(19) United States
(12) Patent Application Publication
(10) Pub. No.: US 2023/0419236 A1
(43) Pub. Date: Dec. 28, 2023

(54) FACILITATING PHYSICAL GIFTING FROM A VIRTUAL ENVIRONMENT

(71) Applicant: Hallmark Cards, Incorporated, Kansas City, MO (US)

(72) Inventors: Jennifer Richards Garbos, Kansas City, MO (US); Timothy Charles Janes, Olathe, KS (US); William David Moses, Kansas City, MO (US); Gary Thomas Pratt, Lawrence, KS (US); Kevin Weldon Swanson, Kansas City, MO (US)

(21) Appl. No.: 18/215,109

(22) Filed: Jun. 27, 2023

Related U.S. Application Data
(60) Provisional application No. 63/460,253, filed on Apr. 18, 2023.
(60) Provisional application No. 63/356,177, filed on Jun. 28, 2022.
(60) Provisional application No. 63/460,248, filed on Apr. 18, 2023.

(51) Int. Cl. G06Q 10/083

(52) U.S. Cl. CPC G06Q 10/083

(57) ABSTRACT

A system and method is provided that incident to a triggering event within a virtual environment, includes receiving recipient-profile information of an initial recipient who is associated with the virtual environment and configuration information of a first physical product that is useable to facilitate conveying the first physical product in the real world to the initial recipient and utilizing the descriptive information to facilitate conveying the first physical product to the initial recipient.

### CROSS-REFERENCE TO RELATED APPLICATIONS

This application claims the benefit of priority of the following three provisional applications: (1) U.S. Provisional Application No. 63/460,253 filed Apr. 18, 2023 entitled “GIFTING, PRESENTING, AND CONVEYING SYSTEMS AND METHODS”; (2) U.S. Provisional Application No. 63/356,177 filed Jun. 28, 2022 entitled “SYSTEM AND METHOD FOR VIRTUALIZED OFFERINGS”; and (3) U.S. Provisional Application No. 63/460,248 filed Apr. 18, 2023 entitled “CURATING, ASSOCIATING, AND CONVEYING MEMORY REPRESENTATIONS.” This application incorporates by reference herein all of the aforementioned patent applications in their entirety for all purposes.

### BACKGROUND

Although people can interact with each other via representative avatars in virtual environments (such as the metaverse or portions thereof), those interactions are often short-lived. But even short interactions can be powerful. For example, a parent who is on a business trip might be able to virtually attend a child's virtual graduation ceremony, friends can attend a concert in the metaverse together, colleagues can onboard a new job in the metaverse, and a mobility-impaired person might be able to join a virtual birthday party held in the metaverse. Even if these types of virtual activities or interactions are short in duration, they can be weighty in emotional importance and social connection, favorably contributing to people's mental health and overall well-being.

Some people desire to further commemorate an achievement or activity. The desire to additionally convey recognition or otherwise supplement a virtual interaction with a physical interaction in real life. The state of the art could be improved by providing a system and method to facilitate delivering a product in the physical world based on happenings in a virtual environment.

### BRIEF DESCRIPTION OF THE DRAWINGS

FIG. 1A is a block diagram of an illustrative computing device suitable for use in implementing aspects of the technology described herein;

FIG. 1B is a first illustrative operating environment suitable for use in practicing aspects of the technology described herein;

FIG. 2 is a second illustrative operating environment suitable for use in practicing aspects of the technology described herein;

FIG. 3 is an illustrative flow diagram that depicts a process in accordance with the technology disclosed herein;

FIG. 4 is an illustrative flow diagram that depicts a process in accordance with the technology disclosed herein; and

FIG. 5 is an illustrative flow diagram that depicts a process in accordance with the technology disclosed herein.

### DETAILED DESCRIPTION

Introduction

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Use of articles or terms, such as “a” or “any”, that might otherwise seem to refer to items in the singular refer to items in the plural herein, such as “one or more.”

Each method aspect described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

As one skilled in the art will appreciate, embodiments of the invention may be embodied as, among other things: a method, system, or set of instructions embodied on one or more computer-readable media. Accordingly, the embodiments may take the form of a hardware embodiment, a software embodiment, or an embodiment combining software and hardware, including in a virtualized environment such as the metaverse. In one embodiment, the invention takes the form of a computer-program product that includes computer-usable instructions embodied on one or more computer-readable media.

Exemplary Computing Devices.

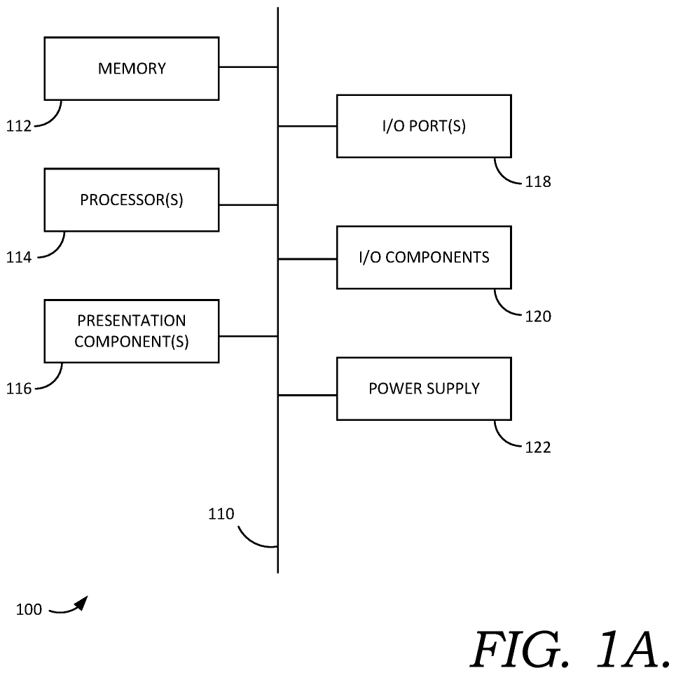

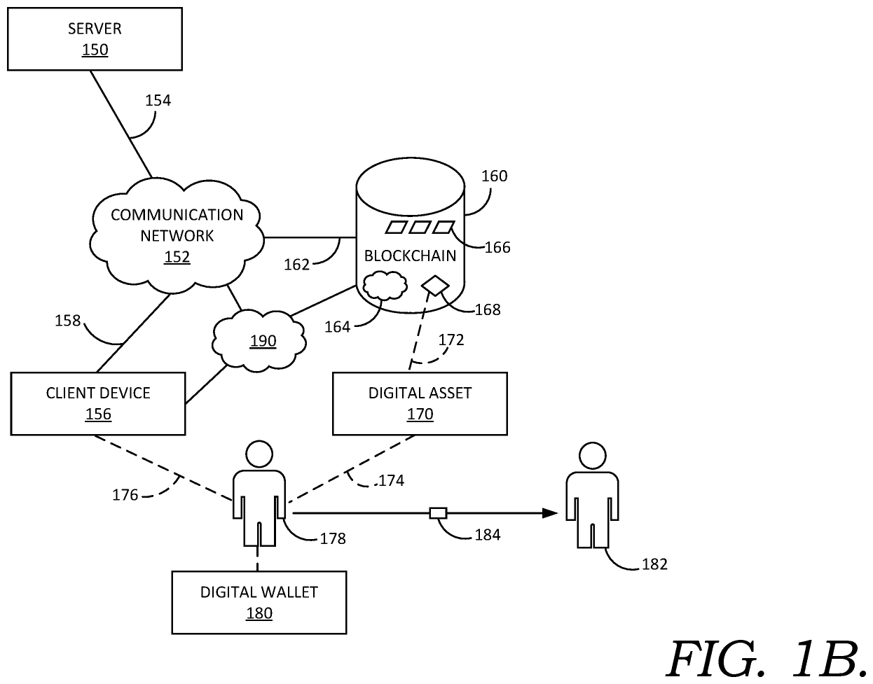

With reference to FIG. 1, a computing device 100 includes a bus 110 that directly or indirectly couples the following devices: memory 112, one or more processors 114, one or more presentation components 116, one or more input/output (I/O) ports 118, one or more I/O components 120, and an illustrative power supply 122. Bus 110 represents what may be one or more busses (such as an address bus, data bus, or combination thereof). Although the various blocks of FIG. 1 are shown with lines for the sake of clarity, these blocks represent logical, not necessarily actual, components. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. (For example, presentation component 116 may be embodied as presentation component 130 and/or may be used as part of user interface 155 of FIG. 1A.) Distinction is not made between such categories as “workstation,” “server,” “laptop,” “handheld device,” etc., as all are contemplated within the scope of FIG. 1 and with reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors 114 that read data from various entities such as memory 112 or I/O components 120. Presentation component(s) 116 presents data indications to a user or other device. Exemplary presentation components include a display device, including a projector, speaker, printing component, vibrating component, presentation component 130, user interface, and/or the like.

The I/O ports 118 allow computing device 100 to be logically coupled to other devices, including I/O components 120, some of which may be built in. Illustrative components include a microphone, joystick, game pad, satellite dish, scanner, printer, wireless communication device, etc. The I/O components 120 may provide a natural user interface (NUI) that processes air gestures, voice, or other physiological inputs generated by a user, for example, a user touching, motioning towards, selecting, or pointing to content projected onto a surface in a presentation environment. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, acoustic, infrared camera systems, RGB camera systems, RF-interference detection, or the like, and/or a combination of these for gesture detection and recognition. Additionally, the computing device 100 may be equipped with (or operate in conjunction with) accelerometers or gyroscopes that enable detection of motion. The output of the accelerometers or gyroscopes may be provided to the display of the computing device 100 to render immersive augmented reality or virtual reality.

Exemplary Technical Setting.

Referring to the metaverse can be a reference to a universal and immersive virtual world (or portions thereof) that is facilitated by the use technologies such as virtual reality (VR) and augmented reality (AR) headsets. It can also refer to a network of 3D virtual worlds that facilitate social connections. It could also refer to virtualized realities that reflect real life, such as “The Sandbox” or “Decentraland.” As used herein, the term “metaverse” includes all of these definitions and also extends to virtualized environments (including gaming environments) that facilitate interacting with others in a virtualized setting.

FIG. 1B depicts an illustrative operating environment suitable for practicing an embodiment of the present invention. A server 150 is coupled to a communication network 152 by way of a logical or physical link 154. Server 150 could take the form of the computing device 100 depicted in FIG. 1A. Link 154 could be a wired or wireless link. Communications network 152 could be a telecommunications network, data network, long-distance network, short-range network, or any type of communications network.

Server 150 is coupled to client device 156 through communications network 152 by way of link 158, which is similar in nature to link 154. Communications network 152 is coupled to a blockchain 160 by way of link 162. Blockchain 160 could utilize distributed-ledger technology and is capable of facilitating interaction with a smart contract 164. Smart contract 164 is a set of code that executes automatically and deterministically in response to a set of inputs. Information to and from blockchain 160 can be facilitated by way of one or more oracles.

Blockchain 160 (variously referred to as a blockchain database) stores a series of transactions represented by numeral 166. In this way, a non-fungible token 168 or number of tokens (“NFTs”) can be kept track of by way of blockchain 160. Although technically, NFT 168 might be a token stored on blockchain 160, herein, the term “NFT” is used synonymously herein to refer to a digital asset 170 to which NFT 160 refers (this nomenclature is adopted because, colloquially, artisans or the general public often refer to the digital asset as the NFT, despite there being a technical distinction). Blockchain 160 can be, for example, the Ethereum blockchain or similar. Item 160 also represents multiple blockchains, include side chains, shard chains, or chains at different layers, such as layer-2 blockchains that rollup transactions or report only net results on an underlying layer-1 chain.

In some embodiments, digital asset 170 is associated with user 178, as represented by dashed line 174. For example, a user's digital wallet 180 is useable to access the public & private keys that are associated with digital asset 170. As indicated by broken line 176, user 178 can also be associated with client device 156, which could be a computer, mobile phone etc., and could include metaverse-related hardware such as a VR headset or other.

In FIG. 1B (and all figures), items depicted in the singular could be multiple (e.g., serve 150 could be multiple servers, communications network 152 could be multiple networks, etc.). All or a portion of the various items depicted facilitate interaction with a virtualized environment 190.

Illustrative Context for the Disclosed Technology.

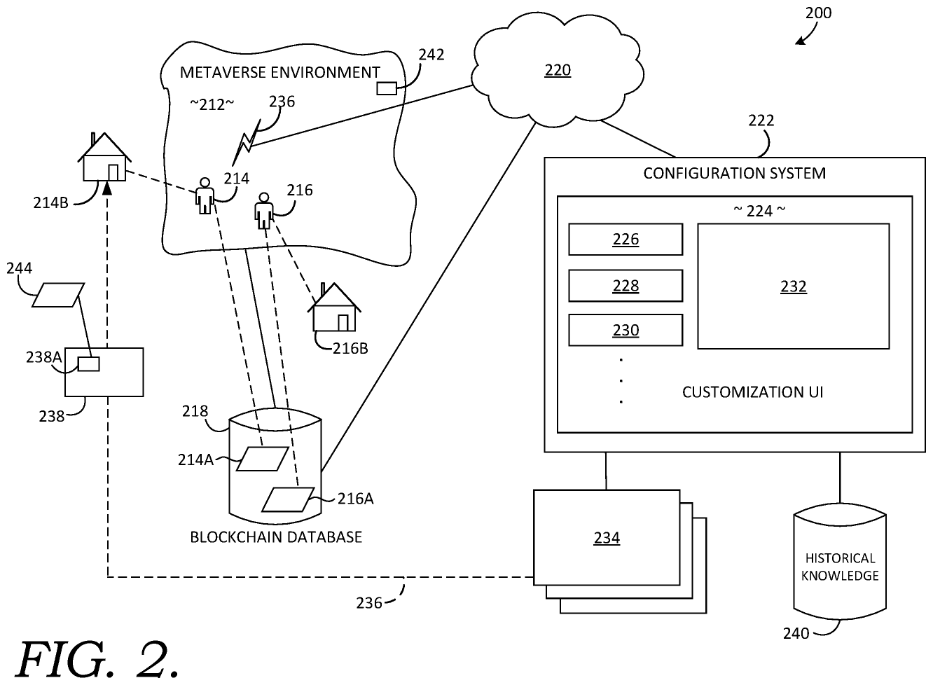

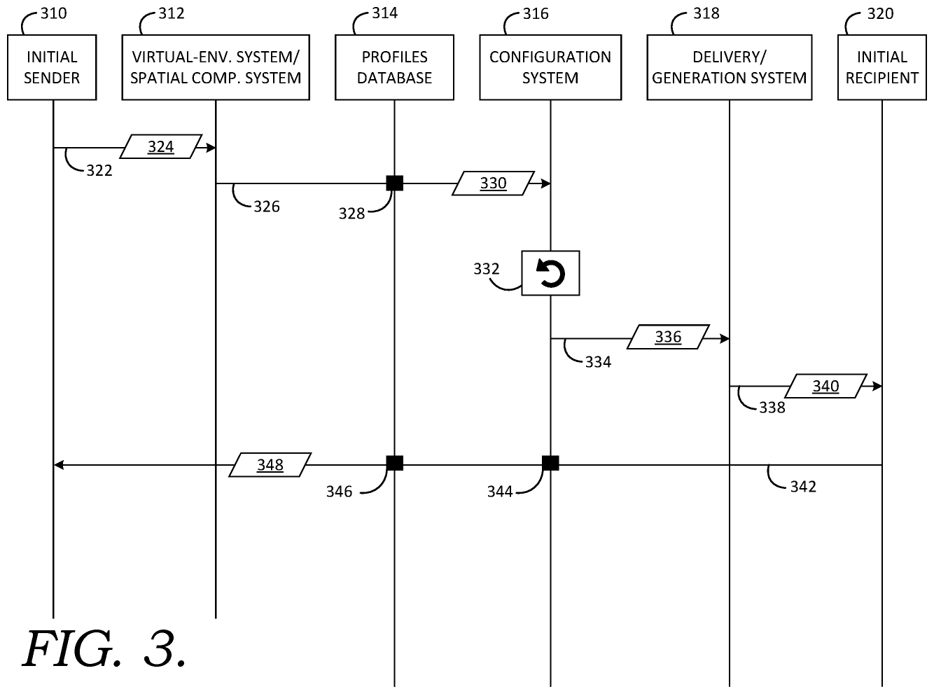

Turning now to FIG. 2, an illustrative operating environment 200 for practicing and embodiment of the disclosed technology is provided. Operating environment 200 includes a virtualized environment 212. Virtual environment 212 preferably includes at least a metaverse portion. Virtual environment 212 is presented by a virtual-environment system or spatial-computing system (such as item 312 in FIG. 3).

Virtualized environment 212, in some embodiments, provides a mirroring of real-world situations along with idealized or imagined virtual components. For example, two illustrative avatars are pictured and referenced by numerals 214 and 216. In one aspect of the disclosed technology, avatar 216 is a virtual representation of a first user and avatar 214 is a virtual representation of a second user.

Database 218 is communicatively coupled to virtualized environment 212. In one embodiment, coupling includes being a part of metaverse environment 212. Database 218 can be a blockchain database. One of the advantages of employing blockchain database is that it facilitates limiting disclosure or access to information associated with users. For example, presume that avatar 216 is associated with a person in real life such as a sender who desires to send a physical product to the physical counterpart of second avatar 214. Blockchain database 218 can be used to limit the disclosure of personal data even if the database itself is publicly accessible.

User 216 is associated with a user profile 216. User profile 216A includes as much information as use your 216 would like to include. For example, in some embodiments, user profile 216A includes a physical address associated with a residence 216 B open paren or work address, etc.). Likewise, user 214 is associated with a second user profile 214A, which also includes address information associated with physical location 214B in one embodiment.

Because database 218 is a blockchain database, Sharing such address information this made easier, such that each person's address information need not be revealed to the other.

Operating environment 200 includes one or more communications networks 220 that are coupled to a configuration system 222, which can include computing devices such as that of FIG. 1A. Configuration system 222 allows for the configuration of a product that sender 216 desires to have sent to recipient 214.

In one embodiment, configuration system 222 presents a customization user interface 224 that includes a set of configuration fields, illustratively represented by numerals 226, 228, 230 and 232. Customization user interface 224 could include many more or fewer fields. User interface 224 allows sender 216 to customize the product to be sent to a recipient's address 214B.

For example, if user 216 desires to send a physical greeting card to user 214, then configuration system 222 can be used to present user interface 224, which would allow the greeting card to be customized. The customization can be carried out by way of user 216 providing input or automatically. For example, in one embodiment, configuration system 222 is coupled to historical-knowledge database 240, which facilitates using the historical knowledge of transactions between customers to inform what type of customization should be applied to a product, aspects more fully described in the aforementioned provisional applications (e.g., those having application Nos. 63/460,253, 63/356,177, and 63/460,248—all of which are incorporated by reference herein).

For example, if sender 216 indicates a desire to send a greeting card to recipient 214, historical-knowledge database 240 could utilize the information in the respective user profiles 214A and 216A to propose greeting-card content, such as one or more images, wording, pictures, videos, or combinations thereof. Historical-knowledge database 240 could also be used to propose a gift in the first place. For example, if user 216 indicates a desire to send a gift to recipient 214 but does not know what to send, then configuration system 222, by way of historical-knowledge database 240 and the information in the user profiles in blockchain database 218 could automatically propose a set of gifts via user interface 224, which could be presented on a computing device such as a PC or mobile phone and which could take the form of that described in FIG. 1A.

As another example, suppose user 216 customizes a card to say: “That's the way the cookie crumbles.” Based on comments exchanged between players (orally or in a chat feature for example), configuration system 222 could mirror the chat content. It could propose a greeting card with context-relevant pictures. User 216 could override the type of image or suggested narrative that was auto-populated.

Time of year, seasons, etc. may also determine the type of content configuration system 222 suggests.

The given “gift” may be experiential such that it requires interaction on the party of recipient 214 to be fully received, as explained in more detail in U.S. provisional application No. 63/460,253 for example. The gift could be a papercraft item chosen as the gift to send to recipient 214 that corresponds to interactions in the virtual environment 212.

For example, based on the profiles 216A and/or 214A, configuration system 222 can propose sending a Christmas ornament or holiday gift to recipient 214. The gift could be further customized by receiving input from user 216 or accepted as proposed.

In one embodiment, clicking a UI control such as element 242 could trigger a “You Pick” or “Surprise Me” feature that automatically selects a gift (optionally subject to pre-defined constraints, such as less than $50) and sends it to the recipient based on the recipients attributes in his or her profile 214A and completes the whole transaction in a single click or tap.

Configuration system 222 is coupled to one or more delivery systems 234, which help facilitate the delivery of a gift 238 to recipient address 214B, a physical address in the real world (e.g., a residential address, P.O. box, business address, GPS coordinates, etc.). Gift 238 could take on a variety of forms. For example, it could be a greeting card, a figurine, a 3D-generated object (e.g., 3D-printed or liquid-metal printed), a game, a picture, an ornament, etc.

Gift or product 238 could include a scannable code 238A, such as a bar code, QR code, NFC chip, or character string that is useable to retrieve a digital complement 244 aspect of gift 238, as more fully described in U.S. Provisional Application No. 63/460,253, which is incorporated by reference herein. Digital complement 244 could be a video, picture, digital gift, digital greeting, reciprocity information (to enable sending back a gift), etc. Thus, for example, user 216 might opt to send user 214 a greeting card 238 and customize it to include a QR code 238A that links to a video 244. Scanning the QR code 238A with user 216's phone would present a video greeting or other digital counterpart that user 216 could enjoy.

Operating environment 200 contemplates a variety of use cases. For example, user 216 and 214 could have attended a common birthday party in virtualized environment 212. Perhaps recipient 214 invited sender 216 to attend a virtual birthday party in virtualized environment 212. In one embodiment, virtualized environment 212 facilitates avatar 216 giving a virtual gift to avatar 214. An aspect of the disclosed technology allows a deeper social interaction, one that occurs in the real world.

For example, a triggering event, represented by lightning bolt 236, can trigger a real-world transaction. Triggering event 236 can take on a variety of forms. In one example, trigger 236 occurs when avatar 216 attempts to give any product to recipient 214. A visual display could be presented that asks giver 216 if a physical gift is desired to be conveyed to recipient 214. Alternatively or additionally, user 216 can click on a user interface element, which is represented by numeral 242, which can take the form of a user-interface control, such as a button or hyperlink in some embodiments. For example, a user could select button 242 to indicate a desire to convey a gift or otherwise have a product 238 conveyed to recipient address 214B.

In still other embodiments, triggering event 236 takes on different forms. Virtualized environment 212 can be configured to automatically propose a gift (or product to convey) based upon the happening of various events and types of events in virtualized environment 212. For example, avatar 216 could expressed a level of affection or other social interaction favorably directed toward avatar 214, that could be triggering event 236. For example, user 216 giving a “high five” to avatar 214 in virtualized environment 212 could automatically propose on the screen “would you like to send user 214 a gift to commemorate an event?” From there, based on use 216's input, a product could be selected or configured via configuration system 222.

Another illustrative triggering event could include taking a screenshot. The system can sense when a screenshot is taken, which could be understood as an indication of a meaningful event, and thereby prompt the user to start the physical-conveyance process.

Another illustrative trigger could be a keyword or phrase. For example, a user may say: “Grab and send!” That could trigger a completely automatic process with no additional interaction from the user that would result in, for example, the recipient receiving a physical card of a screenshot of the interaction occurring at the time.

Another illustrative trigger could be achieving goals or scores. For example, avatar 214 might achieve a certain milestone in game, then 216 achieves the same milestone. Upon that happening, a physical card could be created with a picture of both avatars achieving that milestone, either in original images side by side, or in a mash-up of the two integrated into digital environment. For example, avatar 216 catches a fish at a given lake. Avatar 214 likewise catches a fish from the same virtual lake in metaverse environment 212. That moment could be captured by way of a photo the depicts both avatars standing by the lake holding their fish.

Similarly, virtualized environment 212 might automatically propose a real-life conveyance upon the occurrence of the virtual conveyance. For example, if user 216 owns an NFT, and conveys that NFT to user 214, virtualized environment 212 could automatically detect that conveyance by way of blockchain database 218, digital-wallet transactions, or other databases not shown, and then propose that a physical conveyance occur to commemorate the virtual conveyance.

Other triggering events or occasions that might automatically or prompt a user to confirm that a physical memorialization should be sent include a metaverse wedding, a holiday party with gift exchange, a reunion in the metaverse, a date, a party in a virtual home where the guest wants to offer a gift for the host or hostess, a physical invitation to meet in the metaverse, a thank-you after meeting in the metaverse, a real-world day brightener inspired by a metaverse interaction, a birthday party, etc.

Turning now to FIG. 3, an illustrative flow diagram illustrates various aspects of the disclosed technology. FIG. 3 references an initial sender 310, which is representative of a sender who wishes to send a physical object to a physical address based on information in a virtualized environment, such as at least a portion of a metaverse environment. A virtual-environment system, variously referred to as a spatial-computing system, is referenced by numeral 312. Spatial-computing system 312 includes the functionality to interact with a virtualized environment, including, in some embodiments, presenting the virtualized environment. A profiles database 314 could be a standalone database or an aspect of virtual-environment system 312.

Profiles database 314 includes profiles associated with users of the virtualized environment. For example, a user profile may be associated with initial sender 310 as well as initial recipient 320. Profile information can include attributes such as demographic information, name, address, preferences, likes, dislikes, and any other information desired to be stored.

A configuration system 316 facilitates configuring a gift or other physical object to be conveyed in the real world to a recipient. Configuration system 316 may be of the same type as configuration system 222.

A delivery system 318 is usable to facilitate delivery of a physical item to a physical address. The system can also facilitate the generation of an object in the case of 3D printing, liquid-metal printing, and other similar types of physical generation-on-demand systems. Alternatively, delivery system 318 could take the form of a configured third-party system that has been interfaced with configuration system 316 such that products that are offered by way of delivery system 318 are also offered in connection with facilitating the physical delivery of a physical product in connection with a virtualized interaction within a virtualized environment.

In an illustrative operation, at a step 322, an indication 324 is communicated by initial sender 310 to virtual-environment system 312. This indication 324 can take the form of indicia that indicates a desire by initial sender 310 to send a physical product to an initial recipient 320. Initial sender 310 does not need to know initial recipient 320's physical address because that information is stored in profiles database 314, which is accessible by configuration system 316. As mentioned, sometimes, in virtualized environments, virtual players desire to remain anonymous or at least pseudonymous with respect to their real-world identities. One of the benefits of the disclosed technology is facilitating physical delivery without disclosure of real-life addresses.

In this way, at a step 326, information 330 is communicated to configuration system 316. Step 326 can include interacting with profiles database 314, as represented by numeral 328 if profiles database 314 is distinct from virtual-environment system 312. If it is not, then information 330, including, for example, physical-address information of initial sender 310, can be communicated directly from virtual-environment system 312 to configuration system 316.

At a step 332, customization information can be provided to customize physical product 340 that is ultimately delivered to initial recipient 320. This customization can be automatic or be accomplished with the input from initial sender 310. For example, in the case of automatic customization, configuration system 316 can receive information from virtual-environment system 312 that is usable to generate an image, video, or other representation of a social interaction that occurred in a virtualized environment. For example, if two people were experiencing a concert in the metaverse and artist information was included as part of information 330, then configuration system 316 could automatically generate a representation of the performing artist, or some other image that is tailored to the shared experience between the sender and recipient could be used.

By way of another example, the sender and recipient might have explored portions of a virtualized world together, such as a slot canyon. If that information was provided as part of information 330, then configuration system 316 could automatically generate a photograph of a real-life slot canyon, such as “The Narrows” of Zion National Park in Utah along with a caption that says: “Maybe we can explore this together sometime?”

Alternatively or additionally, step 332 could include receiving user input from initial sender 310. If sender 310 desires to create his or her own artwork, wording in a card, or even plans for an object to be 3D printed, that information could be provided at step 332.

As previously mentioned, configuration system 316 could include or be coupled to an historical-knowledge database that is composed of many thousands, millions (or more) of transactions between users that chronicles items purchased as well as events, cost, sentiment, and other characteristics that are usable to inform proposals by configuration system 316.

At a step 334, a description of object 340 (or object 340) itself is communicated to delivery system 318. In the case of objects that are created on demand, such as print-on-demand (“POD”) cards, 3D-printed objects, liquid-metal printed objects, etc. That information is useable by delivery system to generate the object or send to another system for such generation and ultimate delivery.

At a step 338, physical object 340 is delivered to initial recipient 320. Delivery can be carried out directly or indirectly. As previously mentioned, delivery to initial recipient 320 can be carried out anonymously such that initial sender 310 was never made aware of the physical address associated with initial recipient 320.

In like manner, if initial recipient 320 desires to reciprocate a gift-giving experience, then, at a step 342, he or she can reverse the process and have an item 348 sent to initial sender 310 either directly or interacting through configuration system 316, represented by numeral 344 and using information from profiles database 314, as represented by numeral 346.

For example, the initial recipient 320 can utilize configuration system 316 to receive proposals as to what might be a good gift to send back to initial sender 310. That determination can be informed by historical-knowledge database 240, which is accessible by configuration system 316. Initial recipient 320 can accept an automatically generated or proposed product. Or initial recipient 320 can customize proposed ideas. Or initial recipient 320 can start from scratch and generate or select an item to be purchased and delivered to initial sender 310 (who would then become a recipient). One of the benefits of the disclosed technology is its ability to propose thoughtful ideas because it has access to profiles database 314 and historical-knowledge database 240.

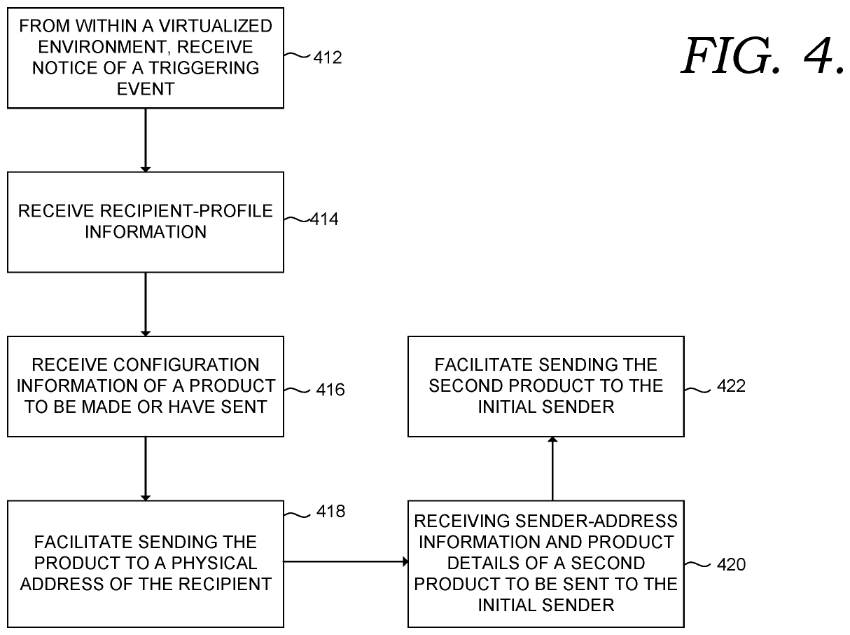

Turning now to FIG. 4, an illustrative method of practicing the disclosed technology is provided. An embodiment of the disclosed technology can take the form of instructions embodied on one or more non-transitory computer-storage media that, when executed by one or more processors of a system, caused the system to perform a process such as depicted in FIG. 4.

In one embodiment, the process includes receiving from within a virtualized environment a notice of a triggering event. The triggering event indicates that a physical item is to be conveyed to an initial recipient. When the notice of a triggering event is received, recipient-profile information of an initial recipient who is associated with the virtual environment is received as well as configuration information. The configuration information describes aspects of the physical product and is usable to facilitate conveying the product in the real world to a real-world address associated with the initial recipient.

Thus, at a step 414, recipient-profile information is received. That information is usable to determine a physical address to deliver the desired physical product. At a step 416, configuration information is received, which is usable to configure aspects of the product to be made or have sent. As described above, the configuration information can be used to automatically customize the product without user interaction or to receive customization instructions from an initial sender.

At a step 418, the system facilitates sending the product to a physical address of the recipient. This can be carried out by communicating delivery or manufacturing instructions to a deliverer or generator that directly or indirectly delivers the product. In this way, at a step 420, sender-address information is received as well as product details of a second product that is to be sent to the initial sender in the case of the initial sender wanting to reciprocally send a product back to the initial sender. For example, the recipient may receive a greeting card that has a QR code, which, upon scanning with his or her phone is coupled to configuration system 222, which is usable to retrieve address information of the initial sender, thereby allowing a “thank you” type of gift to be sent back to the original sender of the original gift.

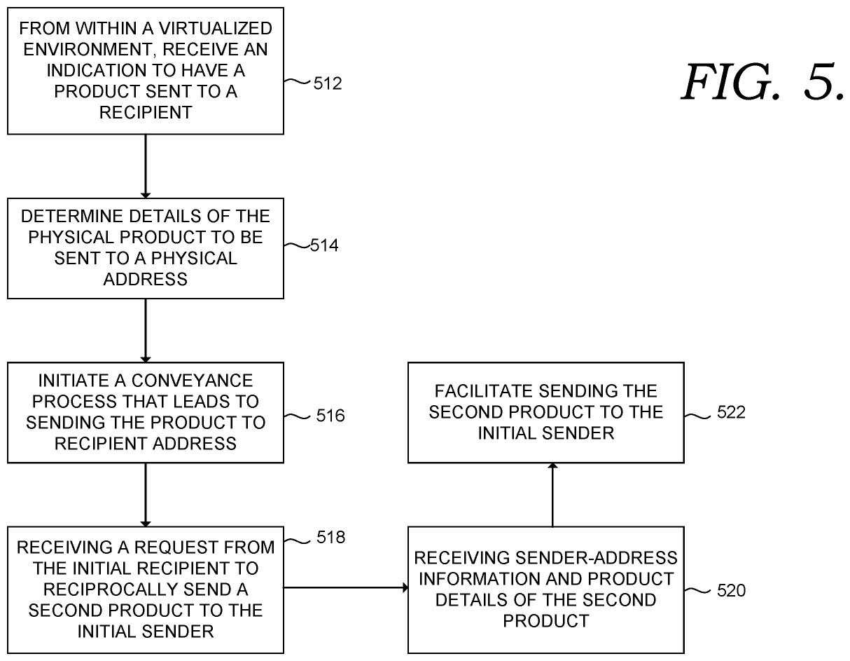

Turning now to FIG. 5, another illustrative method for practicing an embodiment at the disclosed technology is provided. At a step 512, from within a virtualized environment, an indication to have a product sent to a recipient is received.

At a step 514, a determination is made after the details of the physical product to be sent to a physical address. This could include descriptive information associated with the storefront, details of a product to be created, or other information. The physical address could be retrieved by way of a database, such as a blockchain database that includes the physical address information of a target recipient, which can be received without disclosing such information to the initial sender.

At a step 516, a conveyance process is initiated that leads to sending the product to the target recipient address. If the recipient desires to return the sentiment, the system can receive a request from the initial recipient to send a product to the initial sender. This would be accomplished by way of including identifying indicia with the first product, such as a sticker with a QR code, an NFC chip, link to an NFT, or other identifying information. One or more physical stickers, such as sticker sheet could be provided. Alternatively or additionally, the stickers could have images that relate to a player's avatar, virtual interactions with others or happenings in the virtual environment, emotions exhibited during play, or interactions between users that are likely to be commemorated on a physical sticker or item. At a step 520, address information is received that is usable to determine the address to send the second product to. At a step 522, sending the second product to the initial sender is facilitated directly or indirectly.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility, may be employed without reference to other features and sub combinations, and are contemplated within the scope of the claims.

What is claimed is:

1. One or more non-transitory computer-storage media having computer-executable instructions embodied thereon that, when executed by one or more processors of a system, cause the system to perform a method, the method comprising:
incident to a triggering event within a virtual environment, receiving (1) recipient-profile information of a first user who is to become an initial recipient of a first physical product and who is associated with the virtual environment and (2) configuration information of the first physical product that is useable to facilitate conveying the first physical product in the real world to the initial recipient; and
utilizing the recipient-profile information to facilitate conveying the first physical product to the initial recipient.

2. The media of claim 1, wherein the virtual environment is at least a metaverse portion.

3. The media of claim 1, wherein the triggering event includes one or more of the following:
a virtual conveyance in the virtual environment to a representation of the first user in the virtual environment;
receiving a conveyance indication within the virtual environment, wherein the conveyance indication indicates a desire to begin a conveyance transaction; or
from within the virtual environment, receiving a request to receive a desired physical product.

4. The media of claim 1, wherein the recipient profile information includes a first physical address associated with the first user.

5. The media of claim 4, wherein all or a portion of the configuration information is provided by one or more of the following ways:
automatically by a configuration system; or
by receiving customization information from an initial sender.

6. The media of claim 5, wherein an aspect of the configuration information that is provided automatically by the configuration system is based on one or more happenings in the virtual environment and selected without user intervention.

7. The media of claim 6, wherein the aspect of the confirmation information based on one or more happenings in the virtual environment include one or more of the following:
a picture based on a status in the virtual environment;
wording based on a status in the virtual environment; or
an image generated based on a status in the virtual environment.

8. The media of claim 4, wherein the conveying of the first physical product to the first physical address occurs without the first physical address being revealed to the initial sender of the first physical product.

9. The media of claim 1, further comprising a reciprocity process including:
receiving from the initial recipient a second conveyance indication that indicates a desire to have a second physical item sent to the initial sender; and
automatically determining a second physical address associated with the initial sender based on profile information of the initial sender that is associated with the virtual environment.

10. The media of claim 8, wherein the automatically determining a second physical address associated with the initial sender occurs without revealing the second physical address to the initial recipient, thereby enabling an exchange of physical products in the real world without revealing a physical address of either the initial sender or initial recipient to each other.

11. One or more non-transitory computer-storage media having computer-executable instructions embodied thereon that, when executed by one or more processors of a system, cause the system to perform a method, the method comprising:
from within a virtual environment, receiving a first indication of a desire by a first virtual user to convey a first virtual item to a second virtual user;
incident to receiving the first indication, determining that a physical item is to be conveyed to a recipient;
determining a physical mailing address associated with the second virtual user;
identifying the physical item;
initiating a conveyance process that results in delivering the physical item to the physical mailing address.

12. The media of claim 11, wherein the first virtual item is identified by one or more of:
an NFT;
a string of characters that sufficient to identify the virtual item;
an address that corresponds to the first virtual item.

13. The media of claim 11, wherein the virtual environment is at least a metaverse portion.

14. The media of claim 13, wherein the determining that the physical item is to be conveyed to the recipient is determined from the first indication.

15. The media of claim 13, wherein the determining that the physical item is to be conveyed to the recipient includes receiving a response to a prompt in the metaverse environment to confirm that the physical item is to be conveyed to the recipient.

16. The media of claim 15, wherein identifying the physical item includes one or more of the following:
receiving item-identification information from the first virtual user that is sufficient to identify the physical item;
referencing a datastore that maps the first virtual item to the physical item.

17. The media of claim 16, wherein the process that results in delivering the physical item to the physical mailing address includes referencing user-profile information associated with second virtual user.

18. The media of claim 17, wherein referencing user-profile information associated with second virtual user is accomplished without the first user being made aware of the user-profile information and wherein the user-profile information is stored on a blockchain.

19. The media of claim 11, further comprising including an indica with the physical item such that the indica accompanies the delivery of the physical item to the physical mailing address, wherein the indica is sufficient to initiate a reciprocity process that enables the second user to send a second physical item to the first user at a second physical address.

20. A gift conveyance system, comprising:
at least one processor coupled to a profiles database that stores profile information of an initial recipient who is associated with a virtual environment; and
a configuration system coupled to the database that is useable to receive customization information of a physical product to be conveyed to a physical address associated with the initial recipient, wherein the configuration system is coupled with a delivery system that usable to facilitate a delivery process that results in delivery the physical product to the physical address.
